(19) United States
(12) Patent Application Publication
(10) Pub. No.: US 2006/0015631 A1
(43) Pub. Date: Jan. 19, 2006

(54) Method of mediation between applications, and mediation platform for implementing the method

(75) Inventors: Pierre Bregant-Belin, Versainville (FR); Jean-Pierre Boule, Soliers (FR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 11/150,942

(22) Filed: Jun. 13, 2005

(30) Foreign Application Priority Data
Jun. 22, 2004 (EP) 04291575.1

(51) Int. Cl. G06F 15/16

(52) U.S. Cl. 709/230

(57) ABSTRACT

A platform is developed for the mediation of web services via a communication network between web service providers (WSP) and web service customers (WSC). A WSP registers with the platform by sending it identification parameters for setting up a secured connection. To configure a WS, the WSP sends to the platform identification and addressing data and access control data, and the platform also obtains quality of service information that the WSP is capable of providing. A WSC is registered to define a customer profile, and the platform presents to it services accessible according to its profile. One of the WSs made available is selected according to selection information received from the WSC. A link is then set up between the WSC and the selected WS, passing via the platform so that service operation can be monitored.

### BACKGROUND OF THE INVENTION

The present invention relates to communication between heterogeneous applications cooperating on a network, such as the Internet or an intranet, by means of web services (WS).

The WSs facilitate access to heterogeneous applications between companies and thus simplify the data interchanges. Through the WSs, the applications can interact via the network, independently of the language in which they are written, and of the hardware and software platforms on which they are installed.

The WSs are application components accessible on the Internet. They can interact dynamically with other applications using communication protocols based in particular on the Extended Markup Language (XML). These services thus make the applications available on the Internet, without requiring a complete development of these applications.

The WSs use a set of standards based on the XML language to describe the information: the UDDI (Universal Description Discovery and Integration) specification for automatically registering and searching for services; the SOAP (Single Object Access Protocol) specification to enable an application to interchange messages with another remote application independently of their underlying implementation; and the WSDL (Web Service Description Language) specification to enable an application to describe the interface enabling another application to dialogue with it according to the SOAP specification.

The WSs are referenced in a UDDI directory and are used to create distributed applications accessible to other applications. To use a WS, an application must first of all discover it in the UDDI directory, recover the WSDL description of its interface and know which communication protocol(s) it understands. These are normally the http or https protocol or other web-standard protocols. They are designated in the WSDL description.

Currently, a number of publishers offer tools and environments for developing a standard WS interface on an underlying application.

Some publishers (for example Systinet, Microsoft, IBM) propose tools for setting up a UDDI directory of services, and/or offer a service directory operated by themselves. With this type of directory, a provider can publish services intended for potential customers and a customer can search for a service according to criteria proposed by the directory.

Other publishers (for example Amberpoint, Flamenco) propose software tools which can be used to monitor the SOAP messages interchanged (for example, response time, errors) and apply certain processes to them (for example rerouting, logging).

Some companies (for example British Telecom, Cable & Wireless) propose WS test or hosting environments for improving their quality.

Other companies (for example Grand Central) propose a closed network with proprietary tools so that a certain number of guarantees and services can be provided during interchanges between WS providers and customers. The closed approach forces the customers and providers to use a specific communication network.

The problem with these different tools is that they constitute software building blocks which cause difficulties in terms of integration and/or compatibility. Setting up WSs consequently entails major efforts on the part of the customer and the provider. Moreover, various aspects such as security, orchestration and management are not yet fully standardized, and the standards in some cases provide a number of possible implementation scenarios. Thus, a lot of energy is expended by the WS providers and/or customers in adapting to the choices made by their partners and succeeding in joining them together. Furthermore, this integration and adaptation work is not normally considered to be the concern of the core competence of the service provider/customer.

Another problem is that the WS customer must search by himself for providers' WSs without necessarily having selection criteria, particularly in terms of QoS (quality of service). For example, one and the same web service offered by two different providers does not necessarily give the same quality of service from one provider to another, and the customer has no way of obtaining this kind of information.

In practice, even if such information were entered by the provider in a public UDDI directory, there would be no guarantee as to the veracity or reliability of this information given that the role of the UDDI directory is simply to present the service and not to monitor the actual service consumption. Another aspect not taken into account by a UDDI directory concerns the level of trust that a customer can have in the provider that he finds in the directory (and, conversely, the provider contacted by the customer has no way of assessing the level of trust that he can grant to this new customer).

Moreover, while the UDDI directory is capable of listing the services satisfying such or such a criterion and of providing information for implementing these various services, actually joining them together may still not necessarily be possible. In most cases, this is due to particular usage constraints associated with security (for example, recovery of certificates, login and password), and commercial aspects (for example, determining the payment mode, the rate).

An object of the present invention is to overcome these various limitations of the prior art.

### SUMMARY OF THE INVENTION

The invention thus proposes a method of mediation between web service providers (WSP) and web service customers (WSC) via a communication network. This method comprises the steps of:
registering at least one web service provider with a mediation platform (MPF) linked to the network;
configuring at least one web service that the provider makes available via the mediation platform, whereby the provider sends to the platform service identification and addressing data and service access control data and the platform obtains information on the quality of service that the provider is capable of providing;
presenting accessible services to at least one web service customer;
selecting one of the web services made available, according to selection information received from the customer; and
setting up a link between the customer and the selected web service, said link passing via the mediation platform for the monitoring of service operation.

Another aspect of the present invention relates to the mediation platform used in the above method.

Access to the various functionalities of the mediation platform is restricted to registered providers and customers, which reinforces security. The profiles enable each of the users to make use of functionalities of the platform suited to their requirements. Because of the registration step, the WSP remains the master of how he wants to make the services available.

The mediation platform advantageously enables the WSP and the WSC to intercommunicate transparently. Because of this, they do not need to manage the technical constraints involved in communicating with varied entities. It is enough for this variety to be handled by the platform, which provides the requisite translations.

The proposed technique is open to the communication standards. It operates a priori on any type of communication network. It makes it possible to add a certain number of improvements, for example in terms of guaranteeing or monitoring quality of service, ease of integration of WS for customers and providers, limiting the non-core-competence efforts required to offer their WS or use third-party WSs, ease of interconnecting customers/providers.

### BRIEF DESCRIPTION OF THE DRAWINGS

FIG. 1 is a diagram illustrating a communication architecture between a WSP, a WSC and a mediation platform according to the invention.

FIG. 2 is a block diagram of a mediation platform.

FIG. 3 is a diagram illustrating various functionalities of a platform according to the invention.

### DESCRIPTION OF PREFERRED EMBODIMENTS

The WSC is normally an entity or an application wanting to integrate services in WS form, that is, to use services that it is not itself provided with. The WSP is normally an entity or an application providing services in WS form.

The mediation platform (MPF) according to the invention is positioned in a communication network CN to which the WSPs and the WSCs are linked. The communication network CN is, for example, the Internet, an intranet or a combination of Internet and intranet.

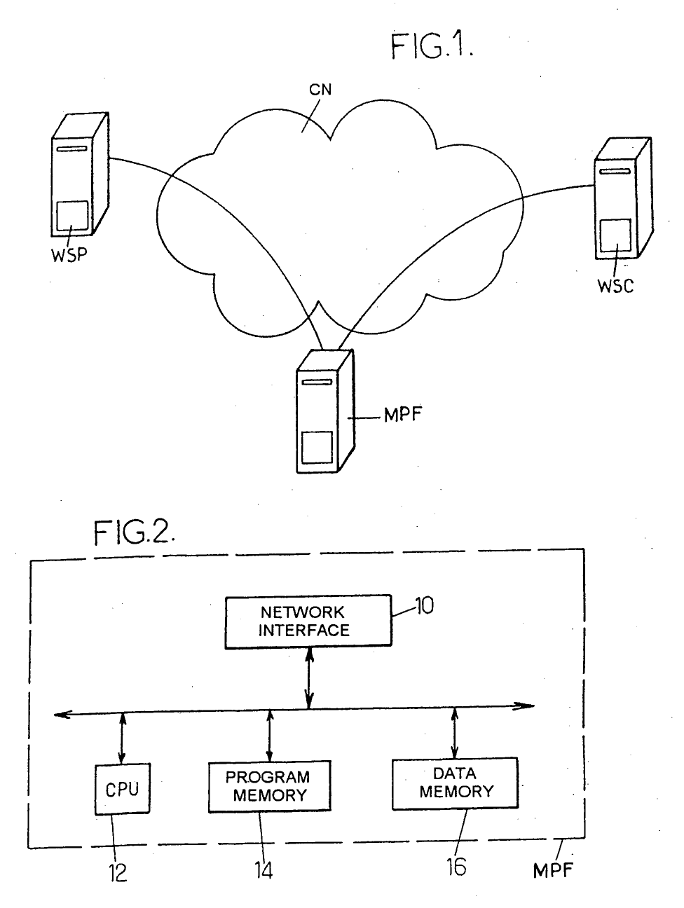

The WSP and the WSC are each represented as a single machine in FIG. 1 for ease of representation. The interchanges take place mainly between applications rather than between an application and an end user. It will be understood that the WSP and the WSC will often each comprise a set of networked computers. On the WSP side, some of these computers host the WSs made available, others (or the same ones) may be used as user terminals for interaction between the provider user and the MPF, and, for example, a router is located at the interface with the outside world. Typically, each WS is denoted by a URL (Uniform Resource Locator) for addressing it in the WSP domain. On the WSC side, some of the computers may host applications using WSs, others (or the same ones) may be used as user terminals for interactions between the customer user and the MPF, and, for example, a router is located at the interface with the outside world.

According to the invention, a WSP (or WSC) may be able to communicate only with the MPF to be able to cooperate with multiple WSCs (or WSPs). The MPF serves as a communication interface between the various players involved in the WSs. The WSP and the WSC thus intercommunicate whatever their hardware platforms and their operating systems (for example Solaris, Unix, etc.), whatever the language in which the applications are written (for example Java, C, etc.) and whatever the communication protocols they support. The MPF is responsible for managing the technical compatibility constraints for setting up two communication paths, one with the WSP and the other with the WSC. Placed end to end, these two paths provide a transparent link for the WSP and the WSC.

Advantageously, the communication paths between the MPF and the WSP and between the MPF and the WSC are secured according to current standards such as WS Security.

The user terminals of the WSP and the WSC each include a browser program (for example Netscape, Internet Explorer, etc.) implementing conventional transfer protocols such as HTTP (Hypertext Transfer Protocol) or FTP (File Transfer Protocol) for accessing a graphical interface provided by the mediation platform.

The graphical interface is publically accessible in the form of an Internet site organized as pages written in a description language such as HTML (HyperText Markup Language). This site will normally be secured by access control and encryption tools for some of the registration.

The graphical interface enables the WSP and the WSC to register with the MPF to access its various functionalities described below. A part of the configuration/registration process can thus be carried out via a WS interface.

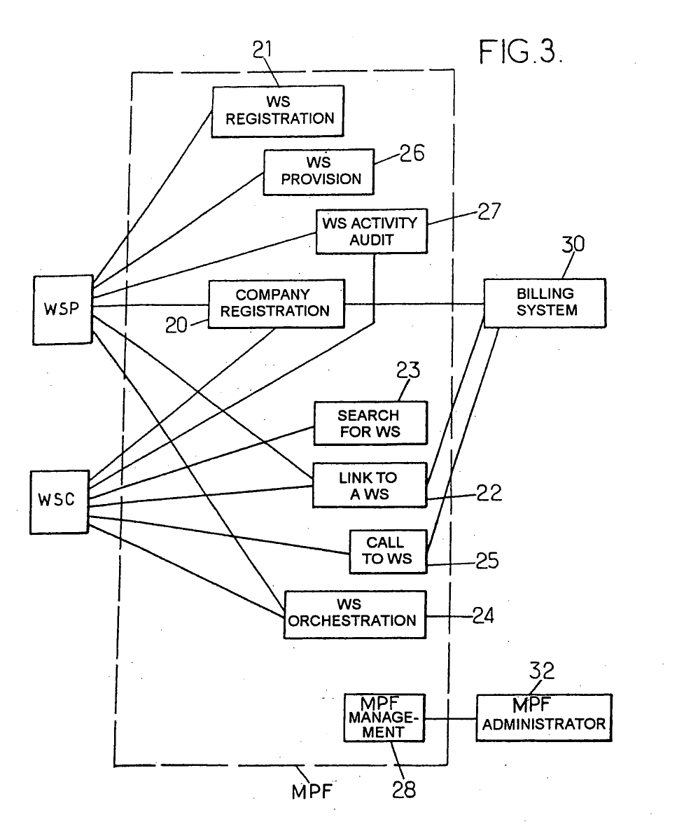

With reference to FIG. 2, the MPF comprises an input/output interface 10 for communicating via the network CN, in particular with WSCs and WSPs, a central processing unit (CPU) 12 for executing the functionalities and services provided by the MPF, and memories 14, 16 for containing on the one hand the programs implementing the software modules 20-28 illustrated by FIG. 3, to be executed by the CPU 12, and on the other hand the data useful to these programs, in particular the user profiles of the WSPs and WSCs, the directory of WSs made available, the data describing the formats supported for the communication interfaces, the HTML pages of the graphical interface, and so on.

In a first step of the method according to the invention, the WSC and the WSP register with the mediation platform to set up user profiles in the MPF. These profiles are used in particular to program the authentication of the users of the MPF and the access control functions of each of the users of the mediation platform MPF. The concept of the user should be understood in this case in the broad sense: the user is a person with respect to the functions accessible via an HTML man-machine interface and an application with respect to the applications accessible by WS.

The MPF has a public interface in the form of a web site designed for human users, or in the form of a WS intended for the application of a WSP or WSC. This interface enables the WSP (or WSC) to obtain information on the services offered by the MPF, to browse the directory of services available on the MPF, at least the publicly accessible services, and register on the MPF to be able to access the functionalities of the MPF.

The initial registration step of the WSP or the WSC is in three stages, controlled by the module 20 of the MPF: (1) minimum registration of mandatory parameters (information needed to identify the WSP or WSC, email address, etc.); (2) verification of these parameters by the MPF (validity of the email address, verification of postal address, authentication by cryptography, etc.), possibly including a physical check by an operator (checking proofs of identity, status, etc.); (3) setting up a secured connection, using currently-applicable standards, such as, for example, SSL (Secure Socket Layer). This secured connection is used to continue registering information on the WSP or the WSC and subsequent interactions with the MPF, ensuring, where appropriate, confidentiality of the data interchanged. During the initial registration, the WSP (or the WSC) provides various information on itself (company name, contact name, address, company category, etc.). The checks made by the MPF are used in constructing the profile of the new entry, in particular its trust level.

During registration, the WSC and the WSP interchange with the MPF, via their respective secured connections, data for complementing their user profile, such as, for example:
the functionalities of the mediation platform MPF that they want to use;
their bank account details for billing for the service provided by the mediation platform MPF. This billing is handled by a billing system 30 which may be external to the MPF as in the example of FIG. 3;
the method of payment; etc.

Once registered, the WSP declares the service or services that he wants to offer, by indicating configuration data such as the name of the service, its type, its function, a description, a WS category, etc. He specifies the quality of service that he is able to provide, for example in terms of response delay time, maximum number of responses per second.

The configuration data may also include service access control data, in particular the WSC customer or customers allowed to use the service on the basis of criteria such as, for example, the financial health of the WSC or the category of the WSC. This can be used, where appropriate, to define services with access restricted to a defined number of customers (“gold” services).

Advantageously, if the WSP does not a priori know some of the quality of service information, the MPF provides him with test means for assessing this information. The reliability and accuracy of these means are directly proportional to the level of intrusion of the MPF accepted by the WSP (for example, placing a measurement probe at the output of the WS server of the WSP, providing the WSP with means of making a call to his own WS via the MPF and providing him with the measurements taken by the probe).

The WSP thus has a test environment for the WS that he wants to make available. This environment enables the WSP to:
check out the operation of the WS with a dummy customer proposed by the MPF, so saving a first customer from any disappointments with the WS offered;
achieve conformity with the technical constraints (however low) of the MPF;
check that the declarations made in the registration step (for example, on the response delay time) can actually be achieved, or, conversely, if nothing has been specified on this subject, making measurements to determine the quality of service parameters to which the WSP may aspire.

Once these tests have been carried out, the module 21 of the MPF registers the WS proposed by the WSP. During this step, the WSP can choose the WSC type that will be allowed to use his WS. This can range from a referencing for any WSC, to a referencing for the WSCs that have such and such a profile, or even only for a particular WSC.

Subsequently, the WSP can alter the information input. The MPF is then responsible for analysing the impact of the changes and the consistency of the data. The changes can, in certain cases, be taken into account immediately, and in other cases be subject to agreements received from one or more WSCs. For example, increasing a response time while a WSC expects a lower response time requires a prior agreement or an end to the use of this WS by this WSC. The MPF is the guarantor of this consistency. If necessary, it sends a notification to the WSC or WSCs affected by the change.

The WSP can also declare other WSs or modify the URLs for accessing the WSs. An advantage provided by the MPF is that the change of URL can be transparent to the WSCs using this WS.

The mediation platform MPF complements the user profile of the WSP by storing, in a secured database, information associated with the WSP, in particular the WSs that he makes available via the MPF, the information associated with quality of service and the WSC customers allowed to use them.

The various services registered are listed in a WS directory. In this directory, the WSs made available by the WSPs are organized according to various classifications: user profiles, categories associated with one or more UNSPSC (United Nations Standard Products and Services Code) domains, with criteria such as their function, their quality of service, their price, etc.

Before being able to go on to the WS operation phase, a WSC begins with a phase for linking to the WS, supervised by the module 22 of the MPF. Once registered, the WSC uses a graphical interface (HTML interface) or a WS interface to browse the directory of services offered by the MPF (module 23). This directory provides technical information describing the services and enabling the WSC to set up the link with the WS. The MPF supplements this information with quality of service criteria such as, for example, average response times, information on WS availability, and sales information (rate, type of billing supported, etc.). The directory has a multicriteria search interface and a service categorization. It displays a view of the WSs dependent on the profile of the registered WSC and the preferences specified by the WSPs (for example, a WSP may have specified that his WS should be seen only by a given WSC).

Once a WS has been found, the WSC enters into the phase for linking to the WS. Initially, he has a test environment offered by the MPF. This environment enables the WSC to integrate the WS in his own application and to test it using the MPF as a virtual WSP, that is, behaving as a WSP at the interface level, but not providing the actual service. The WSP is thus relieved of these tests and of having to set up an environment for each new WSC. If the tests are not validated, the MPF does not offer the WSC the possibility of using the actual WS.

Once these tests have been completed and validated, the WSC is registered as a customer of the WS. The MPF then offers him the possibility of switching, whenever he wants and transparently, to the actual WS or returning to the test WS offered by the MPF. In practice, the MPF offers the WSC the same WS interface and controls the WS actually called. By connecting to the MPF, the WSC has the possibility of deciding if he wants to make a call to a test WS or to the actual WS. The MPF directs the request to the test WS or the true WS located on the WSP server.

If the WSC does not find a WS that meets his requirements, he can express them to the MPF. This expression is, for example, given in plain language. The MPF administrator then tries to find another WSP likely to meet the requirement. He can also respond to this request by constructing a new WS resulting from a combination of a number of WSs available on the MPF. This combination is set up by the orchestration module 24 represented in FIG. 3.

The MPF also provides a WSC with a graphical interface enabling him to specify his requirement by directly describing the combination of WSs in which he is interested. The module 24 is then responsible for orchestrating the specified WSs.

After the phase for linking the WSC to a WS, the WS can be called by the WSC (module 25) and the service provided by the WSP (module 26). The interface between these two modules 25, 26 provides the translations required given the communication formats specified in the user profiles of the WSP and the WSC. In this phase of operation of the WS by the WSC, the MPF can add a number of interesting functionalities:
counting of the calls and transmission of the information necessary to the billing system 30 for payment for the service. The information transmitted and the billing system contacted depend on the preferences expressed by the WSP and the WSC and registered in their respective profiles;
routing of calls. The basic routing consists in redirecting the calls made on the MPF to the WSPs after having carried out an access check. This routing can also depend on parameters such as the specific version of the WS of a WSP, the category (“gold” or other) of a WS reserved for specific WSCs, the load on a server;
isolation of a WSP from a WSC. In addition to the isolation that is provided during the tests described previously, there is an isolation aspect in the context of operation. Certain changes made by the WSP on the way in which a WS is called can be masked by the MPF, for example, a change of access URL on the WSP side;
quality of service monitoring. The MPF checks the quality of service, in particular whether the service has been correctly provided, if the stated response times have been observed, etc. When the quality of service levels approach fixed limits, the MPF can try to make improvements if it can, for example by rerouting the requests to other servers if the WSP declared a number of servers in the registration phase for his WS. If necessary, it reports the risk of exceeding the limits to the users concerned. In the event of an error, the MPF can return a more explicit error message than can usually be expected, for example using email or an SMS service, so that the users concerned can take the appropriate corrective measures. The level of information depends here also on the level of intrusion accepted on the part of the MPF with respect to the WSPs and WSCs;
notarization functions. The MPF can add proofs in cases of dispute between WSP and WSC. For this, it can, if necessary, make use of an independent certifier;
other audit functions provided by the module 27. The calls and responses to the WS are recorded in a history log, reformatted and made available to the WSCs and WSPs, according to their preferences declared in the registration phases. This information is made available by various means (for example, HTML Web interface, WS interface) and can be differentiated, including within one and the same entity. This information has a number of functions: it is used, for example, by the WSP to check who is using his WSs, when or in which circumstances the WS is close to the usage limits within the context of the declared quality of service. It can also be used to monitor the consumption of a particular WS and to know, if appropriate, if there is a need to review the chosen payment method (for example, payment by subscription rather than pay-per-view);
WS version management functions. The WSP can have a number of versions of the same WS. The MPF can redirect the calls from the WSCs to the correct version of the WS, notify the WSCs that a new version is available and provide them with an environment for testing the new interface, and inform the WSPs on the use of these WS versions by the WSCs and their effective migration to the new versions.

These functionalities provided by the MPF require human intervention, in particular for configuring them and for checking their execution. This supervision is provided by a MPF administrator by means of a module 28 for managing the MPF.

The MPF grants a level of trust according to the method of registration chosen by the customer/provider (depending on the method chosen, the MPF carries out minimal checks regarding, for example, an email address, or organizational checks, for example, concerning the existence of a company). A posteriori, it receives “complaints” from customers/providers and can then refine the level of trust allocated to a partner.

The MPF monitors the interchanges between partners, and is therefore capable of taking performance and QoS measurements. It can add this information to the directory made available to the partners and guarantee this information.

The MPF offers the partners a means of registering, giving their preferences/information/choices in terms of payment, security, etc. This is done once while being able to address various partners. It is the MPF that will use the information, set up the security elements and propose the choices to the partners who want to be able to set up links with other partners in the registration and link setup steps. It serves as an intermediary between partners, adding a number of guarantees and functionalities, to facilitate their initial connection and monitor their relationship over time.

In the service orchestration context, the MPF can also be used to facilitate the multiple connections that are then needed (a customer should, without the MPF, be able to negotiate with each provider, adapt to each of them, and so on).

1. Method of mediation between web service providers and web server customers via a communication network, comprising the steps of:
registering at least one web service provider with a mediation platform linked to the network;
configuring at least one web service that the provider makes available via the mediation platform, whereby the provider sends to the platform service identification and addressing data and service access control data and the platform obtains information on the quality of service that the provider is capable of providing;
presenting accessible services to at least one web service customer;
selecting one of the web services made available, according to selection information received from the customer; and
setting up a link between the customer and the selected web service, said link passing via the mediation platform for the monitoring of service operation.

2. Method according to claim 1, wherein the step of registering a web service provider with the mediation platform comprises sending from the provider to the platform identification parameters for setting up a secured connection with the platform.

3. Method according to claim 1, further comprising the step of registering the web service customer with the platform to define a customer profile.

4. Method according to claim 3, wherein the customer profile is used to determine the accessible services presented to the web service customer.

5. Method according to claim 1, comprising the step of constructing in the platform a directory of web services made available, on the basis of identification and addressing data, quality of service information and access control data received from each web service provider.

6. Method according to claim 5, wherein the presentation of services to the web service customer includes extraction of a part of the directory according to a customer profile defined in a step of registering the web service customer with the platform.

7. Method according to claim 1, wherein the quality of service information is sent by the web service provider to the mediation platform in the web service configuration step.

8. Method according to claim 1, wherein the web service configuration step includes presenting to the provider by the mediation platform a test environment for assessing the quality of service information.

9. Method according to claim 1, further comprising the step of testing the service selected by the web service customer, during which the mediation platform presents a test environment simulating the selected service without having set up the link with the web service provider.

10. Method according to claim 9, wherein the web service customer is able to switch to the test environment presented by the mediation platform or the actual service made available by the web service provider.

11. Method according to claim 1, further comprising the step of orchestrating, by the mediation platform, a service requested by a web service customer by combining services made available by at least one web service provider.

12. Method according to claim 1, wherein the monitoring of service operation by the mediation platform includes keeping a count of the calls from the customer to the service and transmitting resultant information to a billing system.

13. Method according to claim 1, wherein the monitoring of service operation by the mediation platform includes an audit in which the calls to the service and the responses from the service are stored in a database in the form of a history that can be accessed by the web service customer and/or provider.

14. Method according to claim 1, wherein the monitoring of service operation by the mediation platform includes a notarization in which the mediation platform records proofs of operation of the service in case of dispute between web service provider and customer.

15. Method according to claim 1, wherein the monitoring of service operation by the mediation platform includes a check on the service quality achieved by the web service provider.

16. Method according to claim 1, wherein the monitoring of service operation by the mediation platform includes functions for managing multiple versions of the web service.

17. Mediation platform between web service providers and web service customers via a communication network, comprising:
means of interfacing with the network;
means of registering at least one web service provider;
means of configuring at least one web service that the provider makes available via the mediation platform, for receiving from the provider service identification and addressing data and service access control data, and obtaining information on the quality of service that the provider is capable of providing;
means of presenting accessible services to at least one web service customer;
means for selecting one of the web services made available, according to selection information received from the customer; and
means of setting up a link between the customer and the selected web service, said link passing via the mediation platform for the monitoring of service operation.

18. Mediation platform according to claim 17, wherein the registration means are arranged to receive from a web service provider identification parameters for setting up a secured connection with the platform.

19. Mediation platform according to claim 17, further comprising means of registering at least one web service customer to define a customer profile.

20. Mediation platform according to claim 17, wherein the customer profile is used to determine the accessible services presented to the web service customer.

21. Mediation platform according to claim 17, comprising means of constructing a directory of web services made available, on the basis of identification and addressing data, quality of service information and access control data received from each web service provider.

22. Mediation platform according to claim 17, wherein the web service configuration means include means of presenting to the provider a test environment for assessing the quality of service information.

23. Mediation platform according to claim 17, further comprising means of testing the service selected by the web service customer, to present a test environment simulating the selected service without the link with the web service provider being set up.

24. Mediation platform according to claim 17, further comprising means for orchestrating a service requested by a web service customer by combining the services made available by at least one web service provider.
